(19) United States
(12) Patent Application Publication
(10) Pub. No.: US 2002/0089647 A1
(43) Pub. Date: Jul. 11, 2002

(54) Optical pathway design for an optical system

(76) Inventor: Guan-Jey Leu, Taipei Hsien (TW)

Correspondence Address: J.C. PATENTS INC., 4 Venture, Suite 250, Irvine, CA, 92618, US

(21) Appl. No.: 09/812,215

(22) Filed: Mar. 19, 2001

(30) Foreign Application Priority Data
Jan. 11, 2001 (TW) 90100588

(51) Int. Cl. G03B 21/14

(52) U.S. Cl. 353/20; 353/31; 349/9

(57) ABSTRACT

An optical path design for an optical system. The design includes a light source, an S-P converter, a polarizing beam splitter, and a plurality of dichroic mirrors and a plurality of color liquid crystal panels for dealing with lights of different colors. Light from the light source passes through the S-P converter and travels to a beam-splitting assembly that includes the polarizing beam splitter and the dichroic mirrors. The three primary colors within the source beam, including red, green and blue, are split so that each travels a different optical path. Dichroic mirror or optical filter is installed along the optical paths of each primary color so that strayed lights are deflected away from the optical system or absorbed. Liquid crystal panels are also installed along the optical paths of each primary color so that the primary colors are reflected back along the same optical paths towards the polarizing beam splitter. After collimating together by the polarizing beam splitter, the reflected primary colors from various liquid crystal panels are projected onto a screen.

### CROSS REFERENCE TO RELATED APPLICATION

This application claims the priority benefit of Taiwan application serial no. 90100588, filed Jan. 11, 2001.

### BACKGROUND OF THE INVENTION

1. Field of Invention

The present invention relates to an optical pathway design. More particularly, the present invention relates to an optical pathway for a reflective liquid crystal projector.

2. Description of Related Art

In recent years, the use of liquid crystal display devices have become more widely used. For example, liquid crystal displays are frequently used in televisions, handheld computers, and projectors. In general, the optical projection system inside a liquid crystal projector can be classified into an off-axial type and on-line type. Off-axial design indicates that the incoming light beam from a light source and the out-going light beam from the optical system are not on the same horizontal line. On the other hand, on-line design has both an incoming light beam and an out-going light beam on the same horizontal axis. At present, the method of projection of a projector is further divided into a front projection type and a back projection type. Most back projection types of liquid crystal projectors employ an on-line optical pathway design. In the field of liquid crystal projector design, projection quality, weight and volume of the optical system are all critical in the production of a fine projector.

FIG. 1 is a sketch showing a conventional optical pathway design in a reflective type liquid crystal projector. As shown in FIG. 1, a beam of white light emits from a light source 102 of the optical system 100. After passing through an optical filter, ultraviolet and infrared components of the white light are filtered out. The filtered light travels to a S-P converter and forms a beam of S-polarized white light WS. The white light WS impinges upon a reflecting mirror 104 and reflects to a dichroic mirror (DM) 106. The dichroic mirror 106 splits the incoming white light WS. The dichroic mirror 106 reflects a portion of the white light WS to form a mixed blue-green light beam (BS, GS). The remaining portion of the white light WS penetrates the dichroic mirror 106 and forms a red light beam RS. Through a reflecting mirror 108, the red light RS is deflected to a polarizing beam splitter 110. The polarizing beam splitter 110 reflects the incoming S-polarized red light RS onto a red liquid crystal panel 112. The mixed blue-green light (BS, GS) travels to a dichroic mirror 114. The dichroic mirror 114 reflects a portion of the mixed blue-green light beam (BS, GS) to form a green light beam GS. The remaining portion of the mixed blue-green beam penetrates the dichroic mirror 114 and forms a blue light beam BS. A polarizing beam splitter 116 reflects the incoming S-polarized green light GS onto a green liquid crystal panel 118. A polarizing beam splitter 120 reflects the incoming S-polarized blue light onto a blue liquid crystal panel 122. P-polarized red light RP, green light GP, and blue light BP reflected from the red liquid crystal panel 112, the green liquid crystal panel 118 and the blue liquid crystal panel 122 travel to an X-cube dichroic prism 124. After integrating the red, green, and blue light inside the X-cube dichroic prism 124, the combined light beam passes through a projector lens 126 before projecting onto a screen (not shown).

FIG. 2 is a sketch showing another conventional optical pathway design for a reflective type liquid crystal projector. A white beam emerges from a light source 202 of the optical system 200. The white beam passes through an S-P converter to form an S-polarized white light WS. The white light WS travels to a color selector 203. The color selector 203 converts S-polarized green light GS within the white light WS into P-polarized green light GP without affecting accompanied S-polarized red light RS or S-polarized blue light BS. Therefore, the white light WS that emerges from the color selector 203 includes S-polarized red light RS and blue light BS as well as P-polarized green light GP. The white light WS travels to a system that includes a polarizing beam splitter (PBS) 204, a dichroic beam-splitting prism 206 and a glass cube 207. The system splits the white light WS up so that red R, green G and blue B light project onto a red liquid crystal panel 208, a green liquid crystal panel 210, and a blue liquid crystal panel 212 respectively. Red R, green G and blue B light is reflected from the red liquid crystal panel 208, the green liquid crystal panel 210 and the blue liquid crystal panel 212 travel back along the same optical route. Finally, the reflected red, green, blue light are combined and passed through a projector lens before hitting a screen.

The aforementioned conventional reflective liquid crystal projectors use an optical path design that relies on dichroic mirrors (DM) and polarizing beam splitters (PBS) to split white light into the three primary colors, red, green and blue. However, the colored light may still contain some strayed light from other colors. The contamination is outside the sphere of control of a liquid crystal panel. Ultimately, a heating problem may occur in various optical paths leading to the appearance of strayed lights that may affect contrast when the liquid crystal panel is in a dark state. Moreover, these strayed lights may lead to impure color when the liquid crystal panel is in a bright state. Furthermore, heat generation may also affect the transparency of optical components.

In addition, three polarizing beam splitters and an X-cube dichroic prism are required in the optical system shown in FIG. 1. Similarly, a polarizing beam splitter, a dichroic beam-splitting prism and a glass cube are required in the optical system shown in FIG. 2. In other words, four prisms are used in the first conventional optical design while three prisms are used in the second conventional optical design. Using three or four prisms in an optical system increases not only the weight of a projector but also increases production cost as well.

### SUMMARY OF THE INVENTION

Accordingly, one object of the present invention is to provide an optical pathway design for an optical system. The design utilizes a dichroic mirror and a polarizing beam splitter to serve as a beam-splitting system so that any strayed lights are reflected out of the optical system, thereby reducing heat for various optical paths.

A second object of this invention is to provide an optical pathway design for an optical system. The design utilizes a dichroic mirror and a polarizing beam splitter to serve as a beam-splitting system so that overall weight and production cost of the optical system is lowered.

To achieve these and other advantages and in accordance with the purpose of the invention, as embodied and broadly described herein, the invention provides an optical pathway design for an optical system. In the design, white light from a light source travels to a S-P converter. The light is converted into S-polarized light. The S-polarized light travels to a first color selector so that the S-polarized green light within the light beam is converted into P-polarized green light (GP). The red and the blue light remain S-polarized (RS, BS). The green light GP, the red light RS and the blue light RS travel to a polarizing beam splitter. The polarizing beam splitter permits the green light GP to pass through while reflecting the red light RS, and the blue light BS. The reflected red light RS and the blue light BS travel to a dichroic mirror so that the red light RS and the blue light BS are split apart. A plurality of absorbing filters or dichroic mirrors are installed along the optical paths of the green light GP, the red light RS and the blue light BS. Hence, strayed lights of each color are absorbed or deflected out of the optical system. Green light GS, red light RP, and blue light BP reflected back from various color liquid crystal panels are integrated together through a polarizing beam splitter. Through a second color selector, the S-polarized green light GS is converted into P-polarized green light GP. Finally, the green light GP, the red light RP, and the blue light BP pass through a projector lens before projecting onto a screen.

The invention also provides an alternative optical pathway design for an optical system. In the design, white light from a light source travels to an S-P converter. The light is converted into S-polarized light by the S-P converter. The S-polarized light then travels to a polarizing beam splitter so that the light is reflected to a dichroic mirror. The dichroic mirror permits red light RS and blue light BS to pass through while reflecting green light GS. The reflected green light GS passes through a dichroic mirror so that any strayed lights are deflected out of the optical system. The red light RS and the blue light BS travel to a dichroic mirror so that the red light RS and the blue light BS are split apart. Finally, the green light GP, the red light RP, and the blue light BP pass through the projector lens before projecting onto a screen.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is a sketch showing a conventional optical pathway design for a reflective type liquid crystal projector;

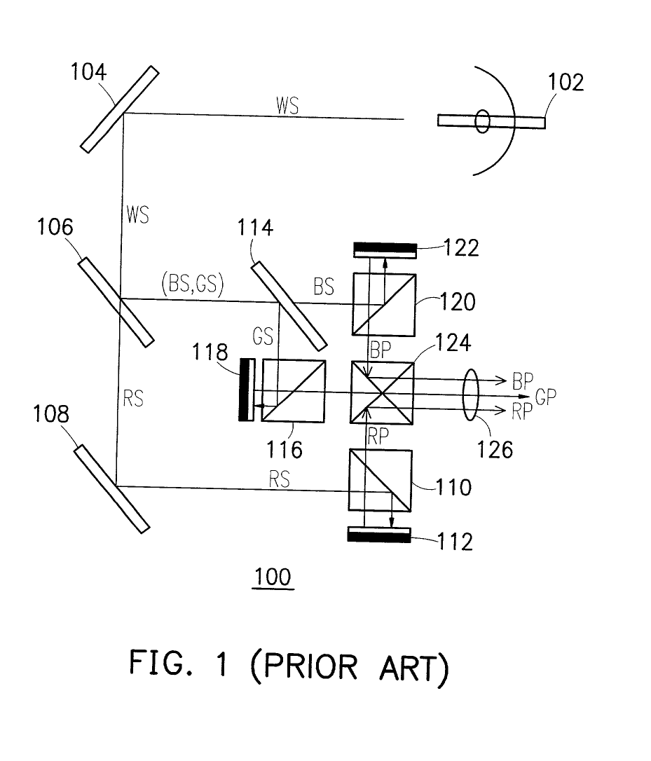

FIG. 2 is a sketch showing another conventional optical pathway design for a reflective type liquid crystal projector;

FIG. 3 is a sketch showing an optical pathway design for a reflective type liquid crystal projector according to a first embodiment of this invention;

FIG. 4 is a sketch showing an optical pathway design for a reflective type liquid crystal projector according to a second embodiment of this invention;

FIG. 5 is a sketch showing an optical pathway design for a reflective type liquid crystal projector according to a third embodiment of this invention; and

FIG. 6 is a sketch showing an optical pathway design for a reflective type liquid crystal projector according to a fourth embodiment of this invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

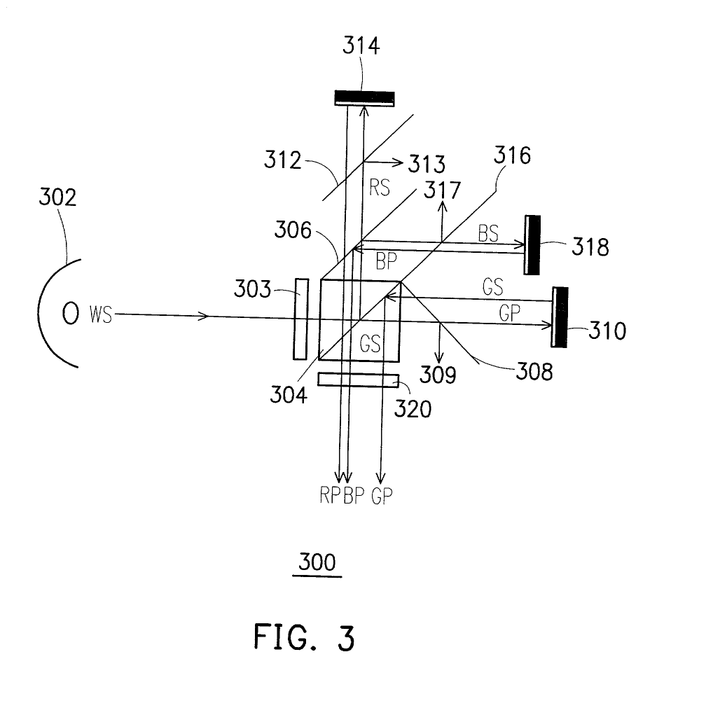

FIG. 3 is a sketch showing an optical pathway design for a reflective type liquid crystal projector according to a first embodiment of this invention. As shown in FIG. 3, a white beam emerges from a light source 302 of the optical system 300. The white beam passes through an optical filter (not shown) so that ultraviolet and infrared light are eliminated before going to an S-P converter to form S-polarized white light WS. The white light WS travels to a color selector 303. The color selector 303 converts S-polarized green light GS within the white light WS into P-polarized green light GP without affecting accompanied S-polarized red light RS or S-polarized blue light BS. Therefore, the white light WS that emerges from the color selector 303 includes S-polarized red light RS, blue light BS, and P-polarized green light GP.

The red light RS, the blue light BS, and the green light GP travel to a polarizing beam splitter 304. The polarizing beam splitter 304 permits green light GP to pass through while reflecting the red light RS, and the blue light BS. The green light GP travels to a dichroic mirror 308 so that strayed lights 309 are deflected from the optical system 300 while the green light GP travels on and arrives at a green liquid crystal panel 310. The reflected red light RS and blue light BS travel to a dichroic mirror 306 so that red light RS is permitted to pass through while the blue light BS is reflected. The red light RS then travels to a dichroic mirror 312 so that strayed lights 313 are deflected out of the optical system 300 while the red light RS travels on and arrives at a red liquid crystal panel 314. The reflected blue light BS travels to a dichroic mirror 316 so that strayed lights 317 are deflected out of the optical system 300 while the blue light BS travels on and arrives at a blue liquid crystal panel 318.

P-polarized red light RP, S-polarized green light GS, and P-polarized blue light BP are reflected from the red liquid crystal panel 314, the green liquid crystal panel 310 and the blue liquid crystal panel 318 respectively. The reflected red light RP, green light GS and blue light BP travel back through their original optical paths and arrive at the polarizing beam splitter 304. The polarizing beam splitter 304 collimates the red light RP, the green light GS, and the blue light BP. The collimated light beam passes through a color selector 320 where the S-polarized green light is also converted to P-polarized green light. Finally, the P-polarized red light RP, the green light GP, and the blue light BP pass through a projector lens (not shown) before projecting onto a screen.

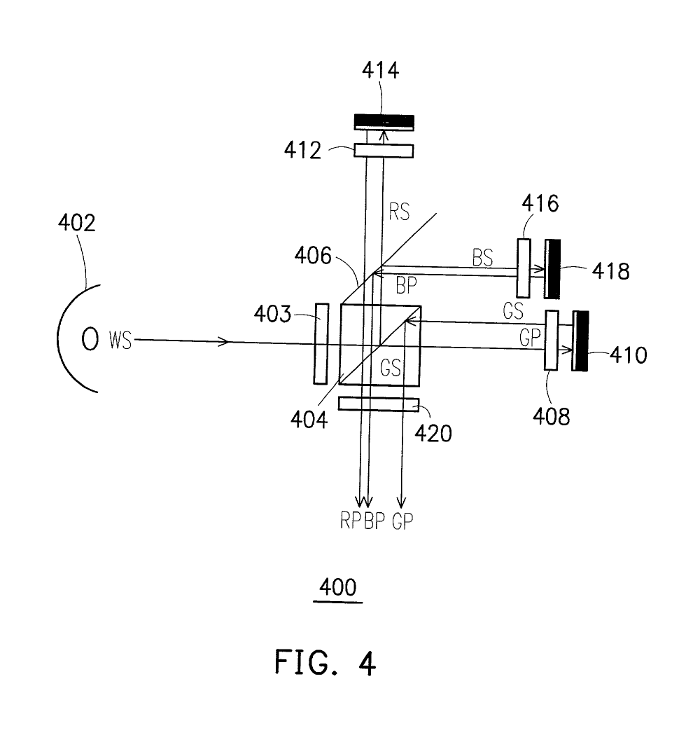

FIG. 4 is a sketch showing an optical pathway design for a reflective type liquid crystal projector according to a second embodiment of this invention. As shown in FIG. 4, a white beam emerges from a light source 402 of the optical system 400. The white beam passes through an optical filter (not shown) so that ultraviolet and infrared light are eliminated before going to an S-P converter to form S-polarized white light WS. The white light WS travels to a color selector 403. The color selector 403 converts S-polarized green light GS within the white light WS into P-polarized green light GP without affecting accompanied S-polarized red light RS or S-polarized blue light BS. Therefore, the white light WS that emerges from the color selector 403 includes S-polarized red light RS, and blue light BS as well as P-polarized green light GP.

The red light RS, the blue light BS and the green light GP travel to a polarizing beam splitter 404. The polarizing beam splitter 404 permits green light GP to pass through while reflecting the red light RS, and the blue light BS. The green light GP travels to an optical filter 408 where strayed lights within the green light GP are absorbed. The filtered green light GP travels to a green liquid crystal panel 410. The reflected red light RS and blue light BS travel to a dichroic mirror 406 so that red light RS is permitted to pass through while the blue light BS is reflected. The red light RS then travels to an optical filter 412 where strayed lights within the red light RS are absorbed. The filtered red light RS travels to a red liquid crystal panel 414. The reflected blue light BS then travels to an optical filter 416 where strayed lights within the blue light BS are absorbed. The filtered blue light BS travels to a blue liquid crystal panel 418.

P-polarized red light RP, S-polarized green light GS, and P-polarized blue light BP are reflected from the red liquid crystal panel 414, the green liquid crystal panel 410 and the blue liquid crystal panel 418 respectively. The reflected red light RP, green light GS, and blue light BP travel back through their original optical paths and arrive at the polarizing beam splitter 404. The polarizing beam splitter 404 collimates the red light RP, the green light GS, and the blue light BP. The collimated light beam passes through a color selector 420 where the S-polarized green light is also converted to P-polarized green light. Finally, the P-polarized red light RP, the green light GP, and the blue light BP pass through a projector lens (not shown) before projecting onto a screen.

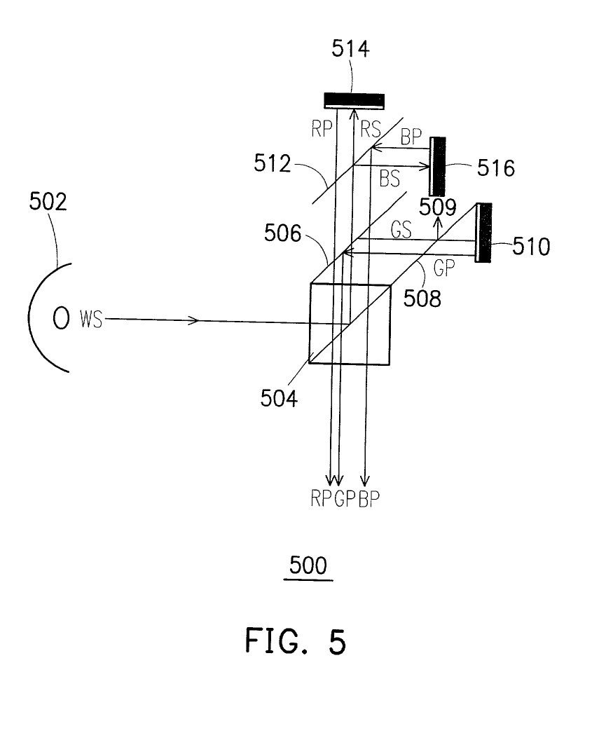

FIG. 5 is a sketch showing an optical pathway design for a reflective type liquid crystal projector according to a third embodiment of this invention. As shown in FIG. 5, a white beam emerges from a light source 502 of the optical system 500. The white beam passes through an optical filter (not shown) so that ultraviolet and infrared light are eliminated before going to an S-P converter to form S-polarized white light WS.

The white light WS travels to a light polarizing beam splitter 504 so that red light RS, green light GS, and blue light BS are all reflected by the beam splitter 504. The reflected red, green and blue lights travel to a dichroic mirror 506. The dichroic mirror 506 permits red light RS, and blue light BS to pass through while reflecting the green light GS.

The reflected green light GS travels to a dichroic mirror 508 where strayed lights 509 are deflected out of the optical system 500. The filtered green light GS travels on and arrives at a green liquid crystal panel 510. The red light RS and the blue light BS travel to a dichroic mirror 512 so that red light RS is permitted to pass through while the blue light BS is reflected. The red light RS travels on and arrives at a red liquid crystal panel 514. The reflected blue light BS travels to a blue liquid crystal panel 516.

P-polarized red light RP, green light GP, and blue light BP are reflected from the red liquid crystal panel 514, the green liquid crystal panel 510, and the blue liquid crystal panel 518 respectively. The reflected red light RP, green light GP, and blue light BP travel back through their original optical paths and arrive at the polarizing beam splitter 504. The polarizing beam splitter 504 collimates the red light RP, the green light GS, and the blue light BP. Finally, the P-polarized red light RP, the green light GP, and the blue light BP pass through a projector lens (not shown) before projecting onto a screen.

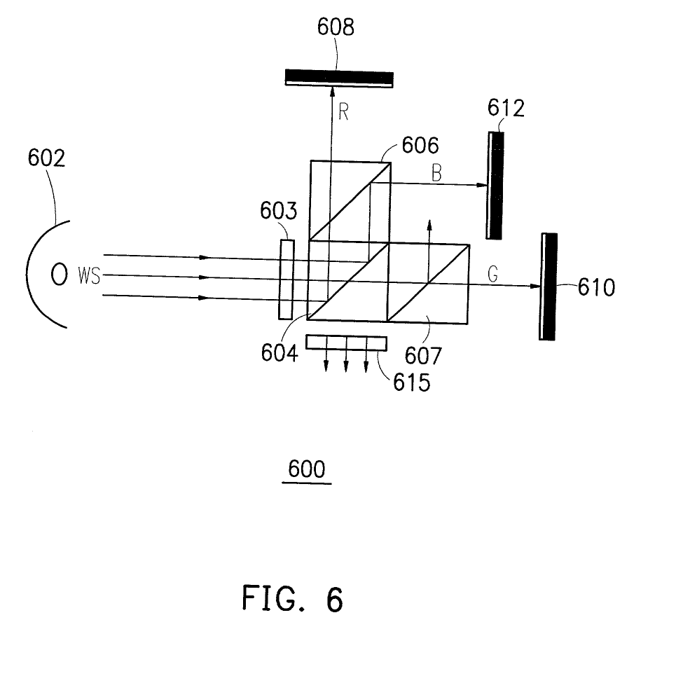

FIG. 6 is a sketch showing an optical pathway design for a reflective type liquid crystal projector according to a fourth embodiment of this invention. As shown in FIG. 6, a white beam emerges from a light source 602 of the optical system 600. The white beam passes through an optical filter (not shown) so that ultraviolet and infrared light are eliminated before going to an S-P converter to form S-polarized white light WS. The white light WS travels to a color selector 603. The color selector 603 converts S-polarized green light GS within the white light WS into P-polarized green light GP without affecting accompanied S-polarized red light RS or S-polarized blue light BS. Therefore, the white light WS that emerges from the color selector 603 includes S-polarized red light RS and blue light BS as well as P-polarized green light GP.

The white light WS travels to a polarizing beam splitter 604 so that red light R and blue light B are reflected while the green light G is permitted to pass through the beam splitter 604. The reflected red light R and blue light B travel to a dichroic cube 606 so that the blue light B is reflected while the red light R is permitted to pass through the dichroic cube 606. A dichroic cube 607 intercepts the green light G so that the strayed lights within the green light G are filtered away. Thereafter, the red light R, the green light G and the blue light B project onto a red liquid crystal panel 608, a green liquid crystal panel 610, and a blue liquid crystal panel 612 respectively. Light reflected from the respective red liquid crystal panel 608, green liquid crystal panel 610 and blue liquid crystal panel 612 travel back through their original optical paths and arrive at the polarizing beam splitter 604. The polarizing beam splitter 604 collimates the red light R, the green light G and the blue light B. Finally, the red light R, the green light G and the blue light B pass through a projector lens (not shown) before projecting onto a screen.

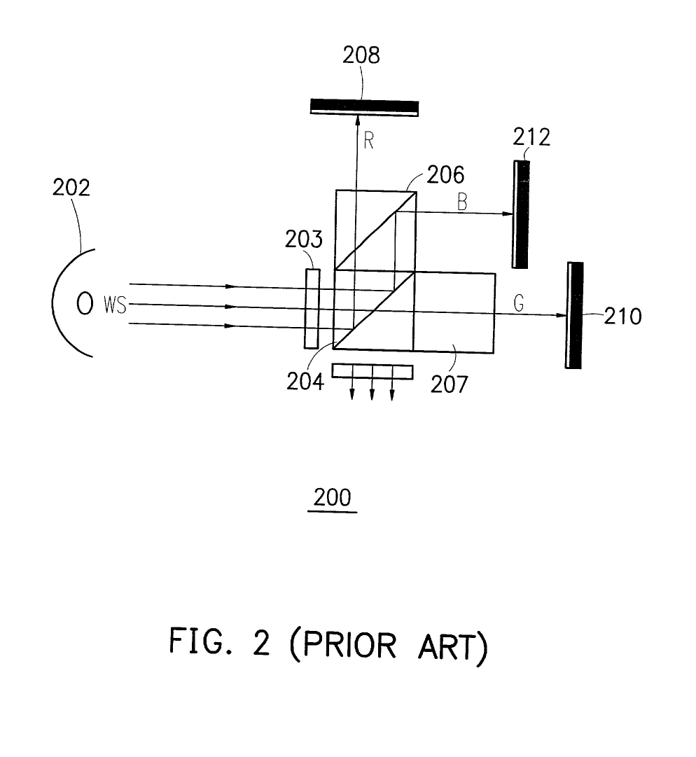

In the fourth embodiment, a dichroic cube 607 replaces the glass cube 207 in the conventional design shown in FIG. 2. The dichroic cube 607 is able to enhance the elimination of strayed lights from the optical system.

In conclusion, the advantages of this invention include:

1. Dichroic mirrors and polarizing splitters together forms a beam-splitting system that deflects strayed lights from the optical system. Hence, heat reduction along the optical paths is improved.

2. Using a multiple of dichroic mirrors and a polarizing beam splitter to serve as a beam splitting system, only one prism is employed. Hence, weight and production cost of the optical system is lowered.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An optical pathway design for an optical system inside a reflective liquid crystal projector such that the optical system serves to split a light beam from a source into a first primary color, a second primary color and a third primary color, comprising:
a first color selector installed along the optical path traveled by the source beam so that the polarized state of the first primary color within the light source is transformed;
a polarizing beam splitter installed after the color selector along the optical path traveled by the source beam so that the second primary color and the third primary color are reflected while the first primary color is permitted to bypass;
a first dichroic mirror installed after the polarizing beam splitter along the optical path traveled by the second primary color and the third primary color so that the second primary color is permitted to bypass while the third primary color is reflected;
a second dichroic mirror installed after the polarizing beam splitter along the optical path traveled by the first primary color so that strayed lights are filtered; a third dichroic mirror installed after the first dichroic mirror along the optical path traveled by the second primary color so that strayed lights are filtered;
a fourth dichroic mirror installed after the first dichroic mirror along the optical path traveled by the third primary color so that strayed lights are filtered;
a first primary color liquid crystal panel installed after the second dichroic mirror along the optical path traveled by the first primary color so that the first primary color is reflected;
a second primary color liquid crystal panel installed after the third dichroic mirror along the optical path traveled by the second primary color so that the second primary color is reflected;
a third primary color liquid crystal panel installed after the fourth dichroic mirror along the optical path traveled by the third primary color so that the third primary color is reflected; and
a second color selector installed after the polarizing beam splitter along the optical path traveled by the out-going light.

2. The optical pathway design of claim 1, wherein the reflected lights from the first primary color liquid crystal panel, the second primary color liquid crystal panel, and the third primary color liquid crystal panel are collimated by the polarizing beam splitter to form the out-going light.

3. The optical pathway design of claim 2, wherein the design further includes a projector lens installed after the second color selector along the optical path traveled by the out-going light.

4. The optical pathway design of claim 3, wherein the second color selector transforms the polarized state of the first primary color.

5. An optical pathway design for an optical system inside a reflective liquid crystal projector such that the optical system serves to split a light beam from a source into a first primary color, a second primary color and a third primary color, comprising:
a first color selector installed along the optical path traveled by the source beam so that the polarized state of the first primary color within the light source is transformed;
a polarizing beam splitter installed after the color selector along the optical path traveled by the source beam so that the second primary color and the third primary color are reflected while the first primary color is permitted to bypass;
a first dichroic mirror installed after the polarizing beam splitter along the optical path traveled by the second primary color and the third primary color so that the second primary color is permitted to bypass while the third primary color is reflected;
a first optical filter installed after the polarizing beam splitter along the optical path traveled by the first primary color so that strayed lights are absorbed;
a second optical filter installed after the first dichroic mirror along the optical path traveled by the second primary color so that strayed lights are absorbed;
a third optical filter installed after the first dichroic mirror along the optical path traveled by the third primary color so that strayed lights are absorbed;
a first primary color liquid crystal panel installed after the first optical filter along the optical path traveled by the first primary color so that the first primary color is reflected;
a second primary color liquid crystal panel installed after the second optical filter along the optical path traveled by the second primary color so that the second primary color is reflected;
a third primary color liquid crystal panel installed after the third optical filter along the optical path traveled by the third primary color so that the third primary color is reflected; and
a second color selector installed after the polarizing beam splitter along the optical path traveled by the out-going light.

6. The optical pathway design of claim 5, wherein the reflected lights from the first primary color liquid crystal panel, the second primary color liquid crystal panel and the third primary color liquid crystal panel are collimated by the polarizing beam splitter to form the out-going light.

7. The optical pathway design of claim 6, wherein the design further includes a projector lens installed after the second color selector along the optical path traveled by the out-going light.

8. The optical pathway design of claim 5, wherein the second color selector transforms the polarized state of the first primary color.

9. An optical pathway design for an optical system inside a reflective liquid crystal projector such that the optical system serves to split a light beam from a source into a first primary color, a second primary color and a third primary color, comprising:
a polarizing beam splitter installed along the optical path traveled by the source beam so that the source beam is reflected;
a first dichroic mirror installed after the polarizing beam splitter along the optical path traveled by the source beam so that the first primary color is reflected while the second primary color and the third primary color are permitted to bypass
a second dichroic mirror installed after the first dichroic mirror along the optical path traveled by the second primary color and the third primary color so that the second primary color is permitted to bypass while the third primary color is reflected;
a third dichroic mirror installed after the first dichroic mirror along the optical path traveled by the first primary color so that strayed lights are filtered; a first primary color liquid crystal panel installed after the second dichroic mirror along the optical path traveled by the first primary color so that the first primary color is reflected;
a second primary color liquid crystal panel installed after the third dichroic mirror along the optical path traveled by the second primary color so that the second primary color is reflected; and
a third primary color liquid crystal panel installed after the third dichroic mirror along the optical path traveled by the third primary color so that the third primary color is reflected.

10. The optical pathway design of claim 9, wherein the reflected lights from the first primary color liquid crystal panel, the second primary color liquid crystal panel and the third primary color liquid crystal panel are collimated by the polarizing beam splitter to form the out-going light.

11. The optical pathway design of claim 10, wherein the design further includes a projector lens installed after the polarizing beam splitter along the optical path traveled by the out-going light.

12. An optical pathway design for an optical system inside a reflective liquid crystal projector such that the optical system serves to split a light beam from a source into a first primary color, a second primary color and a third primary color, comprising:
a polarizing beam splitter installed along the optical path traveled by the source beam so that the primary color is permitted to bypass while the second primary color and the third primary color are reflected;
a first dichroic cube installed after the polarizing beam splitter along the optical path traveled by the first primary color so that strayed lights are filtered;
a second dichroic cube installed after the polarizing beam splitter along the optical path traveled by the source beam so that the second primary color and the third primary color are permitted to bypass;
a first primary color liquid crystal panel installed after the first dichroic cube along the optical path traveled by the first primary color so that the first primary color is reflected;
a second primary color liquid crystal panel installed after the second dichroic cube along the optical path traveled by the second primary color so that the second primary color is reflected; and
a third primary color liquid crystal panel installed after the second dichroic cube along the optical path traveled by the third primary color so that the third primary color is reflected.

13. The optical pathway design of claim 12, wherein the reflected lights from the first primary color liquid crystal panel, the second primary color liquid crystal panel and the third primary color liquid crystal panel are collimated by the polarizing beam splitter to form the out-going light.

14. The optical pathway design of claim 13, wherein the design further includes a projector lens installed after the polarizing beam splitter along the optical path traveled by the out-going light.
